(19) United States
(12) Patent Application Publication
(10) Pub. No.: US 2021/0291848 A1
(43) Pub. Date: Sep. 23, 2021

(54) ELECTRIC POWER SUPPLY APPARATUS AND VEHICLE

(71) Applicant: HONDA MOTOR CO., LTD., Tokyo (JP)

(72) Inventors: Takashi TSUJIOKA, WAKO-SHI (JP); Daisuke KONDO, WAKO-SHI (JP); Tomonori WATANABE, WAKO-SHI (JP); Osamu SATO, WAKO-SHI (JP); Yuki SEKIBA, WAKO-SHI (JP)

(21) Appl. No.: 17/202,897

(22) Filed: Mar. 16, 2021

(30) Foreign Application Priority Data
Mar. 17, 2020 (JP) 2020-046488

(51) Int. Cl. B60W 50/04; B60W 30/188; B60W 50/10; B60L 3/04; B60W 30/18; B60W 30/16; B60W 40/12; B60R 16/033

(52) U.S. Cl. CPC B60W 50/04; B60W 30/1886; B60W 50/10; B60L 3/04; B60W 30/18018; B60W 2710/00; B60W 40/12; B60R 16/033; B60W 2720/106; B60W 2720/103; B60W 2720/24; B60W 30/16

(57) ABSTRACT

An electric power supply apparatus includes a first power supply that supplies electric power to a first control device configured to control a vehicle, a second power supply that supplies electric power to a second control device configured to control the vehicle, a starter switch configured to be operated by an occupant, and an activation control unit that starts or stops the vehicle based on a change in voltage of the starter switch that occurs when the starter switch is operated, wherein the starter switch is in a state of being connected to the first power supply and the second power supply, and when the starter switch is operated, electric power is supplied to the starter switch from at least one of the first power supply and the second power supply.

### CROSS-REFERENCE TO RELATED APPLICATION

This application is based upon and claims the benefit of priority from Japanese Patent Application No. 2020-046488 filed on Mar. 17, 2020, the contents of which are incorporated herein by reference.

### BACKGROUND OF THE INVENTION

### Field of the Invention

The present invention relates to an electric power supply apparatus and a vehicle including a plurality of electric power systems.

### Description of the Related Art

An object of Japanese Laid-Open Patent Publication No. 2005-170070 is to provide a power supply device for a vehicle capable of controlling power supply for in-vehicle electric equipment even when either an ignition switch or a brake switch is broken down during traveling (paragraph [0006] and Abstract). In order to achieve the above object, the power supply device of Japanese Laid-Open Patent Publication No. 2005-170070 includes a CPU, a battery, an ignition switch provided between the battery and the CPU, and a power supply circuit (Abstract).

The CPU controls the electric equipment for the vehicle (Abstract). The battery supplies electric power to the CPU. The power supply circuit supplies electric power to the CPU bypassing the ignition switch from the battery. A self-retaining relay is provided on the power supply circuit and activated by a signal from a predetermined vehicle switch. The CPU outputs a relay control signal to the self-retaining relay.

In the structure, after the electric power is supplied to the power supply circuit (control means), it is possible to control start/stop of operation of the self-retaining relay (relay means) from the power supply circuit. According to the disclosure, in the structure, even in the case where a failure occurs in one of the ignition switch and the vehicle switch which serves as a trigger for activating the self-retaining relay, it is possible to control power supply for the electric equipment for the vehicle (paragraph [0008]).

### SUMMARY OF THE INVENTION

As described above, Japanese Laid-Open Patent Publication No. 2005-170070 aims to make it possible to control supply of electric power to the in-vehicle electrical equipment even in the case where a failure occurs in one of the ignition switch, the vehicle switch, etc. However, in Japanese Laid-Open Patent Publication No. 2005-170070, cases where two electric power systems are provided have not been studied.

The present invention has been made taking such cases into consideration. An object of the present invention is to provide an electric power supply apparatus and a vehicle that can be used suitably in structure having two electric power systems.

An electric power supply apparatus according to one aspect of the present invention includes: a first power supply configured to supply electric power to a first control device configured to control a vehicle; a second power supply configured to supply electric power to a second control device configured to control the vehicle; a starter switch configured to be operated by an occupant; and a control unit configured to start or stop the vehicle based on a change in voltage of the starter switch that occurs when the starter switch is operated, wherein the starter switch is in a state of being connected to the first power supply and the second power supply, and when the starter switch is operated, electric power is supplied to the starter switch from at least one of the first power supply and the second power supply.

A vehicle according to another aspect of the present invention includes the electric power supply apparatus as described above.

In the present invention, it becomes possible to suitably use the electric power supply apparatus in the structure having the two electric power systems.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing structure for performing travel control in a vehicle according to an embodiment of the present invention;

FIG. 2 is an electric circuit diagram schematically showing an electric power supply apparatus and peripheral components of the electric power supply apparatus of the vehicle according to an embodiment;

FIG. 3 is a flow chart showing operation and control of a second travel electronic control unit according to an embodiment;

FIG. 4 is a flow chart showing operation and control of a second travel electronic control unit according to an embodiment; and

FIG. 5 is a time chart showing an example of operation of first to third switches and the switch control circuit according to an embodiment.

### DESCRIPTION OF THE PREFERRED EMBODIMENTS

### A. Embodiment

### <A-1. Structure>

### [A-1-1. Structure for Travel Control]

### (A-1-1-1. Overall Structure)

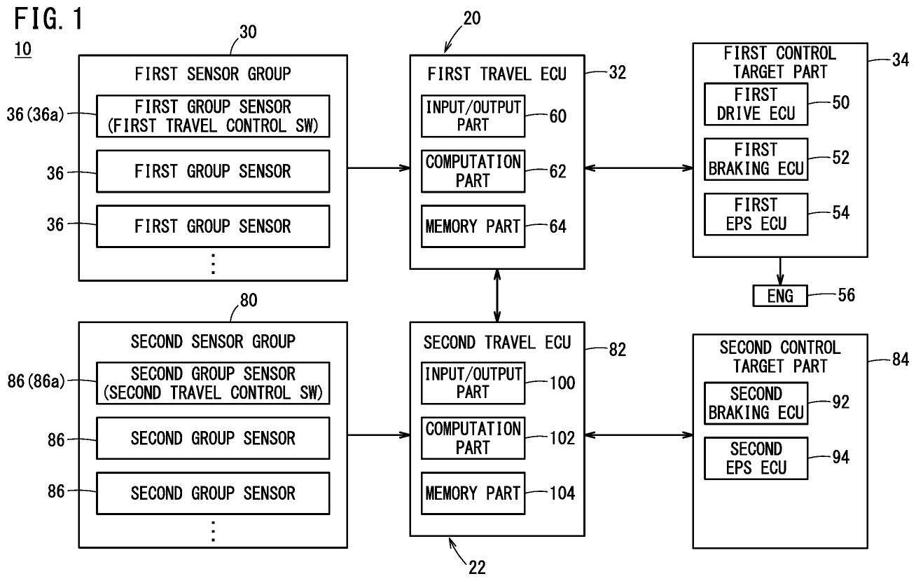

FIG. 1 is a block diagram showing structure for performing travel control in a vehicle 10 according to an embodiment of the present invention. The vehicle 10 includes a first travel control system 20 for performing first travel control, and a second travel control system 22 for performing second travel control. In the first travel control and the second travel control, at least one of acceleration, deceleration, steering, speed conversion of the vehicle 10 is performed automatically (the first travel control and the second travel control will be described later in detail).

### (A-1-1-2. First Travel Control System 20)

### (A-1-1-2-1. Overview of First Travel Control System 20)

As shown in FIG. 1, the first travel control system 20 includes a first sensor group 30. The first travel control system 20 further includes a first travel electronic control unit, that is, a first travel ECU (electronic control unit) 32. The first travel control system 20 further includes a first control target part 34. The first sensor group 30 includes a plurality of first group sensors 36 for obtaining sensor values needed for the first travel control.

### (A-1-1-2-2. First Group Sensors 36)

Examples of the first group sensors 36 include a current position sensor, a vehicle ambient sensor, a vehicle body behavior sensor, a driving operation sensor, and a human machine interface (hereinafter referred to as the “HMI”). The current position sensor detects the current position of the vehicle 10 using a global positioning system (GPS) and the like. As for detection of the current position, a map database of a navigation system (not shown) may be used.

The vehicle ambient sensor detects information about an area around the vehicle 10, that is, the user's own vehicle (hereinafter also referred to as the “vehicle ambient information Ic”). Examples of the vehicle ambient sensor include a plurality of vehicle exterior cameras, at least one radar, a plurality of super sonic sensors, and a LIDAR (Light Detection And Ranging) sensor. Vehicle ambient information Ic is used for detecting obstacles (nearby vehicles, pedestrians, etc.), lane marks, signs, etc. around the vehicle 10, that is, the user's own vehicle.

The vehicle body behavior sensor detects information about behaviors of the vehicle 10 (in particular, vehicle body) (hereinafter also referred to as the “vehicle body behavior information Ib”). Examples of the vehicle body behavior sensor include a vehicle velocity sensor, a lateral acceleration sensor, and a yaw rate sensor. For example, the vehicle body behavior information Ib is used for traveling (acceleration, deceleration, turn, etc.) of the vehicle 10.

The driving operation sensor detects information about driving operation by a driver (hereinafter also referred to as the “driving operation information Io”). Examples of the driving operation sensor include an accelerator pedal sensor, a brake pedal sensor, a steering angle sensor, and a shift position sensor. For example, the driving operation information Io is used for traveling (acceleration, deceleration, turn, etc.) of the vehicle 10.

The HMI receives operation inputs from an occupant (including the driver), that is, a user, and presents various items of information visually or aurally to the occupant. For example, the HMI includes a touch panel. Further, the HMI includes a first travel control switch 36a. The first travel control switch 36a is a switch for providing an instruction to start or end the first travel control by operation of the occupant.

### (A-1-1-2-3. First Control Target Part 34)

The first control target part 34 is a part including a control target of the first travel ECU 32. The first control target part 34 includes a first drive electronic control unit, that is, a first drive ECU 50. The first control target part 34 further includes a first braking electronic control unit, that is, a first braking ECU 52. The first control target part 34 further includes a first electric power steering electronic control unit, that is, a first EPS ECU 54.

The first drive ECU 50 performs drive force control of the vehicle 10 using an accelerator pedal operation amount, etc. detected by the accelerator pedal sensor. At the time of performing the drive force control, the first drive ECU 50 controls the drive control force Fd of the vehicle 10 through control of an engine 56 (drive source). It should be noted that the engine 56 may be regarded as part of the first control target part 34.

The first braking ECU 52 performs braking force control of the vehicle 10 using the brake pedal operation amount, etc. detected by the brake pedal sensor. At the time of performing the brake force control, the first braking ECU 52 controls the brake force Fb of the vehicle 10 through control of a brake mechanism (not shown), etc. The brake mechanism drives a brake member using a brake motor (or a hydraulic mechanism), etc. to generate the brake force Fb of the vehicle 10. That is, in this case, the brake force Fb is generated by a friction force applied between a brake member such as a brake pad and wheels.

In addition to the above, or instead of the above, the brake force Fb may be generated by other methods. For example, in a possible method, the brake force Fb is generated by an engine brake. Further, in the case where the vehicle 10 has a traction motor (not shown), the brake force Fb may be generated accompanying regeneration by the traction motor.

The first EPS ECU 54 controls an EPS motor (not shown) in accordance with an instruction from the first travel ECU 32 to control the turn amount R of the vehicle 10. The turn amount R includes the steering angle θst, the lateral acceleration Glat, and the yaw rate Yr.

### (A-1-1-2-4. First Travel ECU 32)

The first travel ECU 32 is a computer for performing various items of control regarding travel of the vehicle 10. For example, the first travel ECU 32 includes a central processing unit (CPU). The first travel control (described later) is included in the control performed by the first travel ECU 32.

As shown in FIG. 1, the first travel ECU 32 includes an input/output part 60, a computation part 62, and a memory part 64. It should be noted that some functions of the first travel ECU 32 may be carried out by external devices which are present outside the vehicle 10.

The input/output part 60 executes inputs/outputs to/from devices other than the first travel ECU 32 (first sensor group 30, first control target part 34, etc.). The input/output part 60 includes an A/D conversion circuit (not shown) for converting an inputted analog signal to a digital signal.

The computation part 62 performs computation based on signals from the first sensor group 30, etc. Further, the computation part 62 generates a signal for the first control target part 34 based on the computation result. The computation part 62 performs the first travel control (described later).

The computation part 62 realizes various functions by executing programs stored in the memory part 64. The programs may be supplied from external devices through a wireless communication device (not shown). Some functions of the programs may be realized by hardware (circuit components).

The memory part 64 stores programs and data used by the computation part 62. For example, the memory part 64 includes a random access memory (hereinafter referred to as the “RAM”). The RAM includes a volatile memory such as a register, and a non-volatile memory such as a flash memory. Further, the memory part 64 may include a read only memory (hereinafter referred to as the “ROM”) in addition to the RAM.

### (A-1-1-3. Second Travel Control System 22)

### (A-1-1-3-1. Overview of Second Travel Control System 22)

The second travel control system 22 includes a second sensor group 80. The second travel control system 22 further includes a second travel electronic control unit, that is, a second travel ECU (electronic control unit) 82. The second travel control system 22 further includes a second control target part 84. The second sensor group 80 includes a plurality of second group sensors 86 for obtaining sensor values needed for the second travel control.

All or part of sensors of the second group sensors 86 may be identical to those of the first group sensors 36. In this regard, the first group sensors 36 and the second group sensors 86 may share sensors. Alternatively, the second group sensors 86 may include sensors that are different from the first group sensors 36. The HMI of the second sensor group 80 includes a second travel control switch 86a. The second travel control switch 86a is a switch which provides an instruction to start or end the second travel control by operation of the occupant. A switch may be used as a common switch to both of the first travel control switch 36a and the second travel control switch 86a.

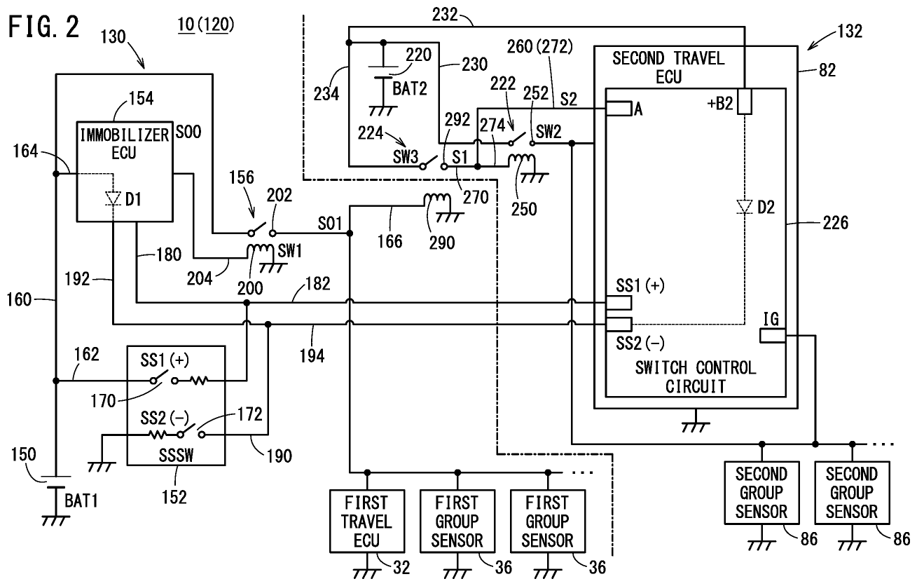

The second travel control is performed by the second travel ECU 82, and the details of the second travel ECU 82 will be described later. A switch control circuit 226 (see FIG. 2) (the details thereof will be described later), that is, a control unit is included in the second travel ECU 82.

The second control target part 84 is a part including a control target of the second travel ECU 82. The second control target part 84 includes a second braking electronic control unit, that is, a second braking ECU 92. The second control target part 84 further includes a second electric power steering electronic control unit, that is, a second EPS ECU 94.

The second braking ECU 92 is the same as the first braking ECU 52 but controls different actuators (not shown). The second EPS ECU 94 is the same as the first EPS ECU 54 but controls different actuators (not shown). The second braking ECU 92 performs braking force control of the vehicle 10 using the brake pedal operation amount, etc. detected by the brake pedal sensor. The second EPS ECU 94 controls an EPS motor in accordance with an instruction from the second travel ECU 82 to control the turn amount R of the vehicle 10. The EPS motor controlled by the second EPS ECU 94 is different from the EPS motor that is controlled by the first travel ECU 32.

### (A-1-1-3-2. Second Travel ECU 82)

The second travel ECU 82 is a computer for performing various items of control regarding travel of the vehicle 10. For example, the second travel ECU 82 includes a central processing unit (CPU). The second travel control (described later) is included in the control performed by the second travel ECU 82.

As shown in FIG. 1, the second travel ECU 82 includes an input/output part 100, a computation part 102, and a memory part 104. It should be noted that some functions of the second travel ECU 82 may be carried out by external devices which are present outside the vehicle 10.

The input/output part 100, the computation part 102, and the memory part 104 of the second travel ECU 82 are the same as the input/output part 60, the computation part 62, and the memory part 64 of the first travel ECU 32. The input/output part 100 executes inputs/outputs to/from devices other than the second travel ECU 82 (second sensor group 80, second control target part 84, etc.).

The computation part 102 performs computation based on signals from the second sensor group 80, etc. Further, the computation part 102 generates a signal for the second control target part 84 based on the computation result. The computation part 102 performs the second travel control (described later). The memory part 104 stores programs and data used by the computation part 102.

### [A-1-2. Structure for Supplying Electric Power]

### (A-1-2-1. Overview)

FIG. 2 is an electric circuit diagram schematically showing an electric power supply apparatus 120 and peripheral components of the electric power supply apparatus 120. The electric power supply apparatus 120 is provided inside the vehicle 10, and supplies electric power to component parts of the vehicle 10. As shown in FIG. 2, the electric power supply apparatus 120 includes a first electric power system 130 using electric power of a first battery 150, and a second electric power system 132 using electric power of a second battery 220. The one dot chain line in FIG. 2 represents a rough border line between the first electric power system 130 and the second electric power system 132.

### (A-1-2-2. First Electric Power System 130)

### (A-1-2-2-1. Overview of First Electric Power System 130)

In addition to the first battery 150, the first electric power system 130 includes a starter switch (activation switch, operation switch) 152. The first electric power system 130 further includes an immobilizer electronic control unit, that is, an immobilizer ECU 154. The first electric power system 130 further includes a first switch 156. Part of a third switch 224 (described later) and/or part of the switch control circuit 226 (described later) may be included in the first electric power system 130.

### (A-1-2-2-2. First Battery 150)

The first battery 150 (first power supply) supplies electric power within the first electric power system 130. For example, the electric power of the first battery 150 is supplied to the first sensor group 30 (first group sensors 36), the first travel ECU 32, and the first control target part 34 (partially omitted in FIG. 2). The first battery 150 outputs the low voltage (e.g., 12V). For example, the first battery 150 is a lead battery. The first battery 150 can be charged based on the electric power from another power supply (not shown) such as an alternator (not shown), for example.

The electric current Ibat1 (or electric power) from the first battery 150 is supplied to the first travel ECU 32 and the first group sensors 36, etc. through a main power line 160 (as described above, in FIG. 2, component parts other than the first travel ECU 32 and the first group sensors 36 have been omitted). Further, the electric current Ibat1 flows toward the starter switch 152 through a first branch power line 162 branching from the main power line 160. Further, the electric current Ibat1 from the first battery 150 is supplied to the immobilizer ECU 154 through a second branch power line 164 branching from the main power line 160. Furthermore, the electric current Ibat1 from the first battery 150 is supplied to a coil 290 (described later) of the third switch 224 through a third branch power line 166 branching from the main power line 160.

### (A-1-2-2-3. Starter Switch 152)

The starter switch 152 (hereinafter also referred to as the “SSSW 152” (SSSW: Start/Stop SWitch)) can be operated by the occupant. The starter switch 152 controls the start and stop of operation of the vehicle 10. The starter switch 152 is a so-called push switch. When the starter switch 152 is pressed, the state of the vehicle 10 changes.

Specifically, if the starter switch 152 is pressed when the vehicle 10 is in the OFF state, the vehicle 10 is placed in an accessory (ACC) state. If the starter switch 152 is pressed when the vehicle is in the ACC state, operation of the engine 56 is started. Additional conditions may be required to start operation of the engine 56 (for example, depression of the brake pedal may be required). If the starter switch 152 is pressed when the engine 56 is in operation and the vehicle 10 is stopped, operation of the engine 56 is stopped, and the vehicle 10 is placed in the OFF state. The vehicle 10 may go through the ACC state before being placed in the OFF state.

As shown in FIG. 2, the starter switch 152 includes a first contact part 170 and a second contact part 172. The first contact part 170 is provided on the first branch power line 162. If the starter switch 152 is pressed by operation of the occupant, the first contact part 170 is placed in the ON state, and if the starter switch 152 is not pressed, the first contact part 170 is placed in the OFF state. The first branch power line 162 divides into a fourth branch power line 180 and a fifth branch power line 182.

The fourth branch power line 180 is connected to the immobilizer ECU 154. The fifth branch power line 182 is connected to an SS1 terminal of the switch control circuit 226. Therefore, it becomes possible for the immobilizer ECU 154 and the switch control circuit 226 to detect the pressed state of the starter switch 152 based on changes in voltage caused by operation of the starter switch 152.

The second contact part 172 is provided on a ground line 190. If the starter switch 152 is pressed by operation of the occupant, the second contact part 172 is placed in the ON state, and if the starter switch 152 is not pressed, the second contact part 172 is placed in the OFF state. The ground line 190 divides into a first branch ground line 192 and a second branch ground line 194. The first branch ground line 192 is connected to the immobilizer ECU 154. The immobilizer ECU 154 is equipped with a diode D1. The cathode of the diode D1 is connected to the first branch ground line 192. The anode of the diode D1 is connected to the first battery 150 through the second branch power line 164. In this way, the second contact part 172 of the starter switch 152 is connected to the first battery 150 through the first branch ground line 192 and the diode D1. The second branch ground line 194 is connected to an SS2 terminal of the switch control circuit 226. The immobilizer ECU 154 and the switch control circuit 226 can detect the pressed state of the starter switch 152 based on changes in voltage of the starter switch 152 that are caused by operation of the starter switch 152. In particular, the immobilizer ECU 154 and the switch control circuit 226 can detect the pressed state of the starter switch 152 based on changes in voltage of the second contact part 172 that are caused by the operation of the starter switch 152.

In the explanation above, the immobilizer ECU 154 has been equipped with the diode D1. However, the embodiment is not limited to this example. The diode D1 may be provided separately from the immobilizer ECU 154. Even in this case, the anode of the diode D1 is connected to the first battery 150 while the cathode of the diode D1 is electrically connected to the second contact part 172 of the starter switch 152.

Although not shown in FIG. 2, the ON/OFF signal of the starter switch 152 is outputted to the first drive ECU 50, etc. through the immobilizer ECU 154.

### (A-1-2-2-4. Immobilizer ECU 154)

For example, the immobilizer ECU 154 has a function of preventing a theft of the vehicle 10 (the detailed description of the immobilizer ECU 154 will be given later).

### (A-1-2-2-5. First Switch 156)

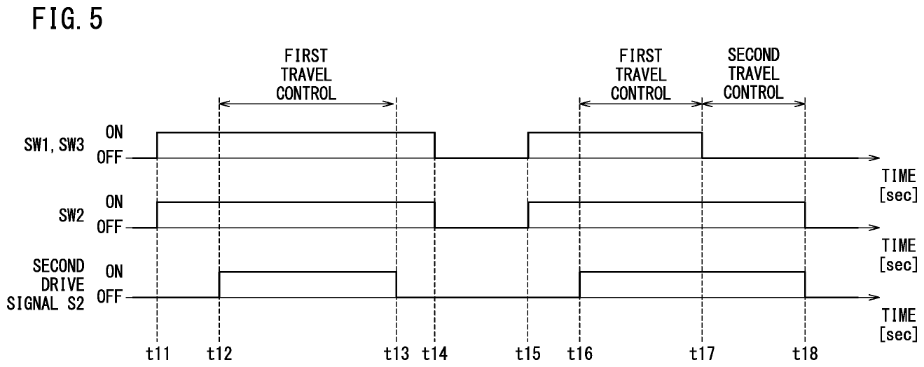

The first switch 156 turns on or off the supply of electric power from the first battery 150 to the first travel ECU 32, etc. The first switch 156 is a normal open type electromagnetic relay, and includes a coil 200 (control input part) and a contact part 202. When the coil 200 is energized, the contact part 202 is placed in the ON state. When the coil 200 is not energized, the contact part 202 is placed in the OFF state. The first switch 156 may comprise other elements (e.g., semiconductor switch). In FIG. 2 and FIG. 5 described later, the first switch 156 is denoted by “SW1”.

The coil 200 is connected to the immobilizer ECU 154 through a signal line 204, and the contact part 202 is placed in the ON state with a drive signal SOO from the immobilizer ECU 154. Thus, the electric current Ibat1 from the first battery 150 is supplied to the first travel ECU 32, etc. In the case where there is no drive signal S00 (Low), the contact part 202 is placed in the OFF state, and the electric current Ibat1 is not supplied to the first travel ECU 32, etc. The immobilizer ECU 154 is operated by electric power from the first battery 150. Therefore, the electric power required for turning on the first switch 156 is supplied from the first battery 150.

### (A-1-2-3. Second Electric Power System 132)

### (A-1-2-3-1. Overview of Second Electric Power System 132)

The second electric power system 132 includes a second switch 222, the third switch 224, and the switch control circuit 226, in addition to the second battery 220.

### (A-1-2-3-2. Second Battery 220)

The second battery 220 supplies electric power within the second electric power system 132. For example, the electric power of the second battery 220 is supplied to the second sensor group 80 (second group sensors 86), the second travel ECU 82, and the second control target part 84 (partially omitted in FIG. 2). The same power supply as the first battery 150 can be used as the second battery 220.

The electric current Ibat2 (or electric power) from the second battery 220 is supplied to the second travel ECU 82, the second group sensors 86, etc. through a main power line 230 (as described above, in FIG. 2, component parts other than the second travel ECU 82 and the second group sensors 86 have been omitted). Further, the electric current Ibat2 is supplied also to an IG terminal of the switch control circuit 226 through the main power line 230. Further, the electric current Ibat2 flows toward the switch control circuit 226 through a first branch power line 232 branching from the main power line 230. Further, the electric current Ibat2 is grounded through a contact part 292 (described later) of the third switch 224 and a coil 250 (described later) of the second switch 222 through a second branch power line 234 branching from the main power line 230.

### (A-1-2-3-3. Second Switch 222)

The second switch 222 turns on or off the supply of electric power from the second battery 220 to the second travel ECU 82, etc. The second switch 222 is a normal open type electromagnetic relay, and includes the coil 250 (control input unit) and a contact part 252 (conductive part). When the coil 250 is energized, the contact part 252 is placed in the ON state, and the electric current Ibat2 from the second battery 220 is supplied to the second travel ECU 82, etc. When the coil 250 is not energized, the contact part 252 is placed in the OFF state, and the electric current Ibat2 is not supplied to the second travel ECU 82, etc. The second switch 222 may comprise other elements (e.g., semiconductor switch). In FIG. 2 and FIG. 5 described later, the second switch 222 is denoted by “SW2”.

One end of the coil 250 is connected to the contact part 292 of the third switch 224 through the second branch power line 234, and connected to the switch control circuit 226 through a signal line 260. Further, the other end of the coil 250 is grounded.

Therefore, when at least one of a first drive signal S1 from the third switch 224 and a second drive signal S2 from the switch control circuit 226 (terminal A) is inputted to the coil 250, the contact part 252 of the second switch 222 is placed in the ON state. Further, if neither the first drive signal S1 nor the second drive signal S2 is inputted to the coil 250, the contact part 252 is placed in the OFF state. Therefore, the second switch 222, the third switch 224, the switch control circuit 226, and the signal line 260 form a self-retaining circuit.

Hereinafter, part of the second branch power line 234 transmitting the first drive signal S1, between the coil 250 of the second switch 222 and the contact part 292 of the third switch 224 will be referred to as a first dedicated signal line 270. Further, part of the second branch power line 234 transmitting the second drive signal S2, between the coil 250 of the second switch 222 and the switch control circuit 226 (i.e., part of the signal line 260) will be referred to as a second dedicated signal line 272. Further, part of the second branch power line 234 transmitting both of the first drive signal S1 and the second drive signal S2, between the coil 250 of the second switch 222 and the contact part 292 of the third switch 224, and between the coil 250 of the second switch 222 and the switch control circuit 226 will be referred to as a common signal line 274.

On the main power line 230, the electric current Ibat2 of the second battery 220 passes through the contact part 252 of the second switch 222. Further, the switch control circuit 226 is operated using electric power supplied from the second battery 220. Therefore, the electric power for turning on the second switch 222 is supplied from the second battery 220. The coil 290 of the third switch 224, meanwhile, is operated using electric power supplied from the first battery 150.

### (A-1-2-3-4. Third Switch 224)

The third switch 224 performs turning-on or -off of the flow of the first drive signal S1 to the second switch 222. The third switch 224 is turned on when the first switch 156 is turned on, and turned off when the first switch 156 is turned off. Stated otherwise, the first switch 156 and the third switch 224 are turned on by operation of the starter switch 152 (common operation by the occupant).

The third switch 224 is a normal open type electromagnetic relay, and includes the coil 290 (control input part) and the contact part 292 (conductive part). When the coil 290 is energized, the contact part 292 is placed in the ON state, and the second switch 222 is turned on. When the coil 290 is not energized, the contact part 292 is placed in the OFF state, and the second switch 222 is turned off as well. The third switch 224 may comprise other elements (e.g., semiconductor switch). In FIG. 2 and FIG. 5 described later, the third switch 224 is denoted by “SW3”.

The coil 290 is connected to the contact part 202 of the first switch 156. Therefore, when the drive signal S01 from the first switch 156 is inputted to the coil 290, the contact part 292 of the third switch 224 is placed in the ON state. If the drive signal S01 is not inputted to the coil 290, the contact part 292 is placed in the OFF state.

The electric current Ibat1 of the first battery 150 passes through the contact part 202 of the first switch 156. Therefore, the electric power required for turning on the third switch 224 is supplied from the first battery 150.

### (A-1-2-4. Switch Control Circuit 226)

When predetermined conditions are satisfied, the switch control circuit 226 outputs the second drive signal S2 to the coil 250 of the second switch 222. An example of the predetermined conditions is that the power supply is given to the IG terminal of the switch control circuit 226 through the main power line 230 from the second battery 220, whereby the switch control circuit 226 transitions from the sleeping state to the operating state. Another example of the predetermined conditions is that the engine 56 is in operation. In this case, when operation of the engine 56 is started, the output of the second drive signal S2 is started, and when operation of the engine 56 is stopped, output of the second drive signal S2 is ended. Alternatively, the predetermined conditions may include the state where the first travel control by the first travel ECU 32 is being performed. In this case, when the first travel condition is started, the output of the second drive signal S2 is started. When the first travel control is ended, the output of the second drive signal S2 is ended. Alternatively, the predetermined conditions may include the state where the second travel control by the second travel ECU 82 is being performed. In this case, when the second travel control is started, the output of the second drive signal S2 is started, and when the second travel control is ended, the output of the second drive signal S2 is ended.

Electric power from the second battery 220 is supplied to the switch control circuit 226 (terminal +B2) through the first branch power line 232. The switch control circuit 226 is equipped with a diode D2. The anode of the diode D2 is connected to the +B2 terminal. The cathode of the diode D2 is connected to the SS2 terminal. The SS2 terminal is, as explained above, connected to the second branch ground line 194. In this way, the second contact part 172 of the starter switch 152 is connected to the second battery 220 through the second branch ground line 194 and the diode D2. As explained above, the immobilizer ECU 154 and the switch control circuit 226 can detect the pressed state of the starter switch 152 based on changes in voltage of the starter switch 152 caused by operation of the starter switch 152. In particular, the immobilizer ECU 154 and the switch control circuit 226 can detect the pressed state of the starter switch 152 based on changes in voltage of the second contact part 172 caused by operation of the starter switch 152.

In the explanation above, the switch control circuit 226 has been equipped with the diode D2. However, the embodiment is not limited to this example. The diode D2 may be provided separately from the switch control circuit 226. Even in this case, the anode of the diode D2 is connected to the second battery 220 while the cathode of the diode D2 is electrically connected to the second contact part 172 of the starter switch 152.

The switch control circuit 226 can function as a control unit, that is, a starter control unit (activation control unit) that starts or stops the vehicle 10 based on changes in voltage of the starter switch 152 that occur when the starter switch 152 is operated.

In the present embodiment, the starter switch 152 is connected to the first battery 150 and the second battery 220. When the starter switch 152 is operated, electric power can be supplied from at least one of the first battery 150 and the second battery 220 to the starter switch 152. For this reason, even if one of the first battery 150 and the second battery 220 fails, the other working battery out of the first battery 150 and the second battery 220 can supply electric power to the starter switch 152. Therefore, according to the present embodiment, even if one of the first battery 150 and the second battery 220 fails, a change in voltage of the starter switch 152 occurs without fail when the starter switch 152 is operated. As a result, according to the present embodiment, the vehicle 10 can be started or stopped without fail based on the operation of the starter switch 152.

### <A-2. Various Controls>

### [A-2-1. First Travel ECU 32]

The first travel ECU 32 performs the first travel control in cooperation with the second travel ECU 82. In the first travel control, automatic driving operation is performed where at least one of acceleration, deceleration, steering, and speed conversion of the vehicle 10 is performed automatically. Examples of automatic driving operation herein include automatic pilot control, lane keep assist control, and automatic lane change control.

### [A-2-2. Second Travel ECU 82]

The second travel ECU 82 performs second travel control whereas the second travel ECU 82 performs the first travel control in cooperation with the first travel ECU 32. In the second travel control, automatic driving operation is performed where at least one of acceleration, deceleration, steering, and speed conversion of the vehicle 10 is performed automatically. The second travel control plays a role of a fail-safe mechanism for the first travel control. That is, the second travel ECU 82 performs the second travel control when abnormality has occurred in the first travel ECU 32 or the first electric power system 130. Automatic driving operation performed in the second travel control may be the same as or different from automatic driving operation performed in the first travel control. In the example illustrated in FIG. 1, since the second travel ECU 82 is not connected to the engine 56, the second travel control is performed with the second braking ECU 92 and the second EPS ECU 94. In this case, automatic driving operation performed in the second travel control may be the control of the vehicle 10 in a way that the vehicle 10 stops in a road side zone.

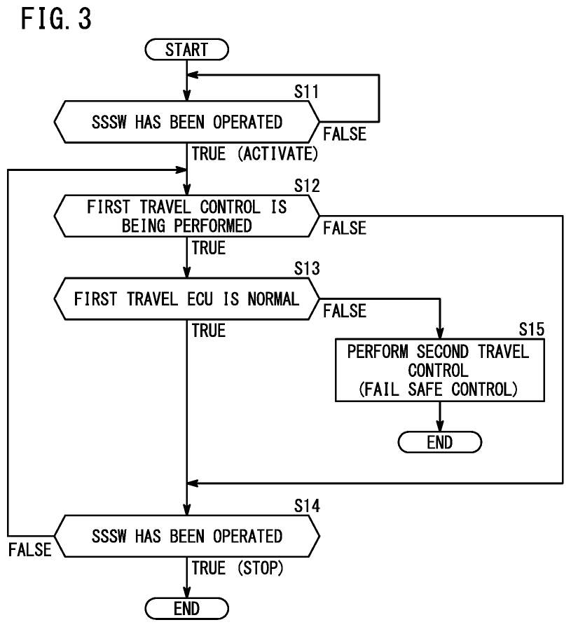

FIG. 3 is a flow chart showing the operation and control of the second travel ECU 82.

In step S11 of FIG. 3, when the SSSW 152 (FIG. 2) is operated, that is when the SSSW 152 is turned on (S11: TRUE), operation of the second travel ECU 82 is started. That is, when the SSSW 152 is turned on, the first switch 156 and the third switch 224 are turned on. Accordingly, the second switch 222 is turned on. As a result, electric power is supplied from the second battery 220 to the second travel ECU 82, and operation of the second travel ECU 82 is started.

After operation of the second travel ECU 82 is started, in step S12, the second travel ECU 82 determines whether or not the first travel control is being performed. For example, this determination is made based on a signal from the first travel control switch 36a (FIG. 1). In the case where the first travel control is being performed (S12: TRUE), the routine proceeds to step S13. In the case where the first travel control is not being performed (S12: FALSE), the routine proceeds to step S14.

In step S13, the second travel ECU 82 determines whether or not the first travel ECU 32 is operating normally. This determination is made based on whether there is a breakdown in the communication between the second travel ECU 82 and the first travel ECU 32 while the second travel ECU 82 and the first travel ECU 32 monitor each other. This determination may be made by monitoring instructions sent from the first travel ECU 32 to the first control target part 34. For example, if the instructions are transmitted at predetermined intervals while the first travel control is being performed, the second travel ECU 82 may determine that the first travel ECU 32 is operating normally. Further, if the transmission of the instructions stops while the first travel control is being performed, the second travel ECU 82 may determine that the first travel ECU 32 is not operating normally.

Alternatively, if the electric current Ibat1 detected by an electric current sensor (one of the first group sensors 36) provided in the first electric power system 130 (e.g., main power line 160) is zero even if the vehicle 10 is placed in the ON state, the second travel ECU 82 may act as follows: in such a case, the second travel ECU 82 may determine that the first travel ECU 32 is not operating normally.

In the case where the first travel control is not being performed (S12: FALSE) or the first travel ECU 32 is operating normally (S13: TRUE), as long as the SSSW 152 is not operated (S14: FALSE), the routine returns to step S12. When the SSSW 152 is operated (S14: TRUE), the second travel ECU 82 is stopped. That is, when the SSSW 152 is operated, since output of the first drive signal S1 from the third switch 224 and output of the second drive signal S2 from the switch control circuit 226 are both stopped, the second travel ECU 82 is stopped.

If the first travel ECU 32 is not operating normally (S13: FALSE), in step S15, the second travel ECU 82 performs the second travel control (fail-safe control). For example, the second travel ECU 82 monitors an area around the vehicle 10 and detects a place where the vehicle 10 is allowed to stop. Then, the second travel ECU 82 moves the vehicle 10 up to the position where the vehicle 10 is allowed to stop, and stops the vehicle 10.

### [A-2-3. Immobilizer ECU 154]

As shown in FIG. 2, the immobilizer ECU 154 is connected to the first battery 150 directly (with no switch in between). Therefore, the immobilizer ECU 154 can operate even when the vehicle 10 is in the OFF state.

The immobilizer ECU 154 monitors the states of the fourth branch power line 180 and the first branch ground line 192, and determines the ON/OFF state of the starter switch 152 (the first contact part 170 and the second contact part 172). That is, the immobilizer ECU 154 determines the ON/OFF state of the starter switch 152 based on changes in voltage caused by the operation of the starter switch 152.

If the starter switch 152 is turned on when the vehicle 10 is in the OFF state, the immobilizer ECU 154 determines whether the vehicle 10 is allowed to be switched to the ACC state (the immobilizer ECU 154 demands authentication). That is, the immobilizer ECU 154 transmits an authentication information request signal to an area around the vehicle 10, that is, the user's own vehicle through a communication device (not shown). When a smart key (not shown) receives the authentication information request signal, the smart key transmits authentication information. If authentication is successful based on the received authentication information, the immobilizer ECU 154 places the vehicle 10 in the ACC state, and if authentication fails, the immobilizer ECU 154 keeps the vehicle 10 in the OFF state.

### [A-2-4. Switch Control Circuit 226]

The switch control circuit 226 (terminal +B2) is connected to the second battery 220 directly (with no switch in between). Therefore, the switch control circuit 226 can operate even when the vehicle 10 is in the OFF state. It should be noted that operation of the switch control circuit 226 is started when the second switch 222 is turned on and the electric current Ibat2 from the second battery 220 is supplied to the IG terminal of the switch control circuit 226 through the main power line 230.

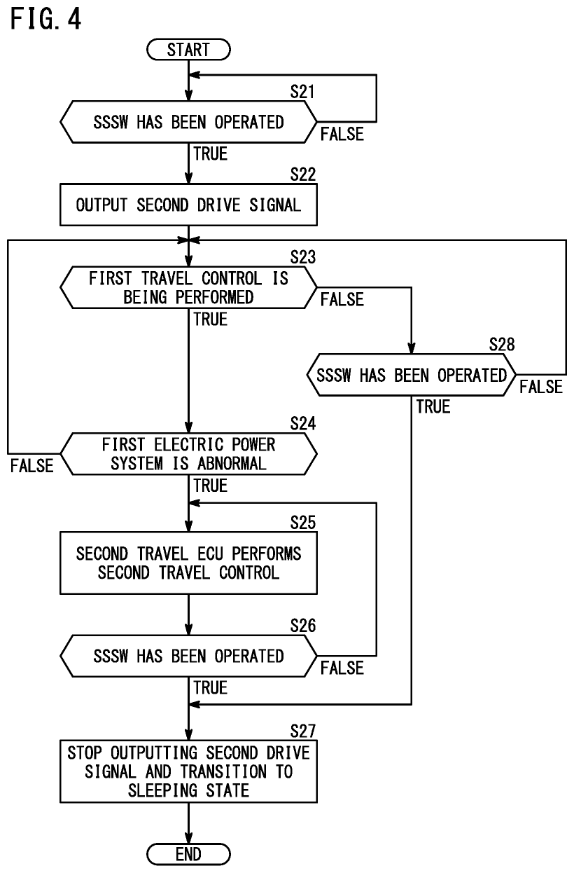

FIG. 4 is a flow chart showing operation and control of the second travel ECU 82. FIG. 5 is a time chart showing an example of operation of the first switch 156, the second switch 222, the third switch 224, and the switch control circuit 226. In FIG. 5, the first switch 156, the second switch 222, and the third switch 224 are denoted by SW1, SW2, SW3. Operation of the switch control circuit 226 is indicated by the second drive signal S2.

In step S21 of FIG. 4, the switch control circuit 226 determines whether or not the SSSW 152 has been operated. If the SSSW 152 has been operated (S21: TRUE), the electric current Ibat2 from the second battery 220 is supplied to the IG terminal of the switch control circuit 226 through the main power line 230. Thus, operation of the switch control circuit 226 is started, and the routine proceeds to step S22. If the SSSW 152 is turned on, and consequently, the first switch 156 and the third switch 224 are turned on, the second switch 222 is turned on as well (time points t11 and t15 of FIG. 5). If the SSSW 152 has not been turned on (S21: FALSE), step S21 is repeated.

In step S22, the switch control circuit 226 outputs the second drive signal S2 to the second switch 222 (time points t12 and t16 in FIG. 5). As a result, even if output of the first drive signal S1 from the third switch 224 is stopped, the second switch 222 is kept in the ON state.

In step S23, the switch control circuit 226 determines whether or not the first travel control is being performed. This determination is made, for example, based on the communication between the switch control circuit 226 and the first travel ECU 32 through a signal line (not shown). If the first travel control is being performed (S23: TRUE), the routine proceeds to step S24.

In step S24, the switch control circuit 226 determines whether or not the first electric power system 130 has abnormality. In the case where the first electric power system 130 has abnormality (S24: TRUE), the routine proceeds to step S25. In the case where the first electric power system 130 does not have abnormality (S24: FALSE), the routine returns to step S23.

In step S25, the second travel ECU 82 performs the second travel control (a time point t17 of FIG. 5).

In step S26, the switch control circuit 226 determines whether or not the SSSW 152 has been operated. For example, the determination is made according to changes in voltage caused by the operation of the SSSW 152. When the SSSW 152 has been operated (S26: TRUE), the routine proceeds to step S27. When the SSSW 152 has not been operated (S26: FALSE), the routine returns to step S25.

In step S27, the switch control circuit 226 stops the output of the second drive signal S2 (time points t13, t18 of FIG. 5) and transitions to the sleeping state (a time point t14 of FIG. 5). As a result, if the output of the first drive signal S1 from the third switch 224 has been stopped, the second switch 222 is turned off.

The routine returns to step S23, and if the first travel control is not being performed (S23: FALSE), in step S28, the switch control circuit 226 determines whether or not the SSSW 152 has been operated. This determination is made in the same manner as step S26. If the SSSW 152 has been operated (S28: TRUE), the routine proceeds to step S27 (a time point t14 in FIG. 5). If the SSSW 152 has not been operated (S28: FALSE), the routine returns to step S23.

### <A-3. Advantages of the Present Embodiment>

In the present embodiment as described above, electric power for the first travel ECU 32 (first control device) is supplied from the first battery 150 (first power supply), and electric power for the second travel ECU 82 (second control device) is supplied from the second battery 220 (second power supply) (FIG. 2). In the structure, electric power is supplied to the first travel ECU 32 and the second travel ECU 82 using different electric power supply systems (first electric power system 130 and second electric power system 132). Therefore, even if abnormality occurs in one of the electric power systems, it becomes possible to continue control of the vehicle 10 by the first travel ECU 32 or the second travel ECU 82 using the other of the electric power systems. Moreover, according to the present embodiment, the starter switch 152 is connected to the first battery 150 and the second battery 220. When the starter switch 152 is operated, at least one of the first battery 150 and the second battery 220 supplies the starter switch 152 with electric power. Thus, even if one of the first battery 150 and the second battery 220 fails, the other one out of the first battery 150 and the second battery 220 can supply the starter switch 152 with electric power. For this reason, even if one of the first battery 150 and the second battery 220 fails, when the starter switch 152 is operated, changes in voltage of the starter switch 152 occur without fail. Therefore, according to this configuration, the vehicle 10 can be started or stopped without fail based on the operation of the starter switch 152. That is, according to this configuration, the electric power supply apparatus 120 can suitably be used for the structure that has two electric power systems.

Further, the first switch 156 and the third switch 224 are turned on by common operation of the occupant (FIG. 2). Therefore, by the common operation of the occupant, it becomes possible to start supply of electric power to the first travel ECU 32 and the second travel ECU 82. That is, when the first switch 156 is turned on, supply of electric power from the first battery 150 to the first travel ECU 32 is started. Further, when the third switch 224 is turned on, the first drive signal S1 is inputted to the second switch 222, and the second switch 222 is turned on. As a result, supply of electric power from the second battery 220 to the second travel ECU 82 is started.

It may be considered to turn on the second switch 222 without using the third switch 224 (or turn on the first switch 156 and the second switch 222 by the common operation). However, in such a case, since supply of electric power from the first battery 150 is interrupted, it becomes impossible to keep the second switch 222 (and the first switch 156) in the ON state.

In the present embodiment, the second switch 222 is turned on when the first drive signal S1 or the second drive signal S2 is inputted, and the second switch 222 is turned off when the first drive signal S1 and the second drive signal S2 are not inputted. Therefore, even if it becomes impossible to keep the “third switch 224” in the ON state due to interruption of supply of electric power from the first battery 150, it is possible to keep the second switch 222 in the ON state with the second drive signal S2 sent from the switch control circuit 226. Stated otherwise, even in the case where the first travel ECU 32 is stopped and the third switch 224 is turned off due to the interruption of the supply of electric power from the first battery 150, it becomes possible to keep the second switch 222 in the ON state with the second drive signal S2. Since the second switch 222 is kept in the ON state with the second drive signal S2, it becomes possible to continue the supply of electric power from the second battery 220 to the second travel ECU 82.

Further, even in the case where it becomes impossible to input the second drive signal S2 to the second switch 222 for some reasons (disconnection of the second dedicated signal line 272 for the second drive signal S2, etc.), the first drive signal S1 is inputted to the second switch 222. Since the first drive signal S1 is inputted to the second switch 222, it becomes possible to continue the supply of electric power to the second travel ECU 82.

As described above, in the present embodiment, it becomes possible to suitably use the electric power supply apparatus 120 for the structure including the two electric power systems.

In the present embodiment, the switch control circuit 226 starts outputting the second drive signal S2 (S22) with an event that the starter switch 152 has been operated by the occupant, as a trigger (S21 in FIG. 4: TRUE).

In this manner, it becomes possible to supply electric power to the second travel ECU 82 in a situation where it is highly necessary to supply electric power to the second travel ECU 82. Further, it becomes possible to suppress standby electric power of the second travel ECU 82 before executing the driving assistance. In particular, in the case where the start of the output of the second drive signal S2 is triggered by the occupant's instruction to start driving assistance by the first travel ECU 32, even if electric power from the first battery 150 cannot be supplied to the first travel ECU 32, etc. for some reasons, it becomes possible to perform driving assistance by the second travel ECU 82.

In the present embodiment, the second travel ECU 82 (second control device) includes the switch control circuit 226. Further, the second travel ECU 82 permits driving assistance by the second travel ECU 82 (S15) if abnormality occurs in the first travel ECU 32 (first control device) (S13: FALSE) while predetermined conditions are satisfied and the switch control circuit 226 keeps the second switch 222 in the ON state with the second drive signal S2 after electric power is supplied from the second battery 220 (second power supply) to the second travel ECU 82 when the second switch 222 is turned on. In this manner, even if it is not possible to perform driving assistance by the first travel ECU 32, it becomes possible to perform driving assistance by the second travel ECU 82.

In the present embodiment, when the starter switch 152 is operated (S26 in FIG. 4: TRUE), the switch control circuit 226 stops the output of the second drive signal S2 (S27). When driving assistance by the first travel ECU 32 (first control device) is stopped (S23: FALSE) and the starter switch 152 is operated (S28 in FIG. 4: TRUE), the switch control circuit 226 stops outputting the second drive signal S2 (S27). In this manner, it becomes possible to stop supply of electric power to the second travel ECU 82 at suitable timing.

In the present embodiment, the first travel ECU 32 (first control device) performs the first travel control in which at least one of acceleration, deceleration, steering, and speed conversion of the vehicle 10 is performed automatically. Further, the second travel ECU 82 (second control device) performs second travel control in which at least one of acceleration, deceleration, steering, and speed conversion of the vehicle 10 is performed automatically. In this manner, in the structure where automatic control can be performed separately by the two control devices, even when the first switch 156, the second switch 222, and the third switch 224 as described above are used, it is possible to suitably achieve the desired redundancy.

### B. Modified Embodiments

The present invention is not limited to the above-described embodiment. Various structures can be adopted based on the description of the specification. For example, the following structure can be adopted.

### <B-1. Structure of Vehicle 10>

### [B-1-1. Overall Structure]

In the structure of the above embodiment, the first travel control system 20 and the second travel control system 22 are separated (FIG. 1). However, the present invention is not limited in terms of using at least the second switch 222 and the third switch 224 for performing ON/OFF control of the second travel ECU 82. For example, part or all of the first sensor group 30 and part or all of the second sensor group 80 may be shared. Likewise, part or all of the first control target part 34 and part or all of the second control target part 84 may be shared.

### [B-1-2. First Battery 150 and Second Battery 220]

In the embodiment, the first battery 150 comprising the lead battery was used as the first power supply for the first electric power system 130 (FIG. 2). However, for example, in terms of supplying electric power to the first electric power system 130, it is possible to use other power supplies instead of or in addition to the first battery 150. Examples of the other power supplies include a lithium ion battery, a capacitor, an alternator, etc. In this case, as necessary, a voltage converter may be used together. The same thing applies to the second battery 220.

### [B-1-3. First Switch 156, Second Switch 222, Third Switch 224]

In the above embodiment, the first switch 156 is an electromagnetic relay having the coil 200 and the contact part 202 (FIG. 2). However, in terms of performing ON/OFF of the second travel ECU 82 using the third switch 224 having the coil 290 (signal input part) of the first electric power system 130 and the contact part 292 (conductive part) of the second electric power system 132, and the signal line 260 from the switch control circuit 226, the present invention is not limited in this respect.

For example, by directly connecting the signal line 204 (FIG. 2) from the immobilizer ECU 154 or the fourth branch power line 180 from the SSSW 152 to the coil 290, it is possible to omit the first switch 156. Alternatively, a fifth switch (not shown) may be provided as another switch on a side closer to the first battery 150 than the first switch 156. Then, it is possible to supply electric power from the first battery 150 to part of the first travel control system 20 through a branch power line branching from between the first switch 156 and the fifth switch.

### [B-1-4. Switch Control Circuit 226]

In the above embodiment, the switch control circuit 226 is part of the second travel ECU 82. However, in terms of controlling the second switch 222 using the second drive signal S2, the present invention not limited in this respect. The switch control circuit 226 and the second travel ECU 82 may be separate component parts.

In the above embodiment, it is assumed that the switch control circuit 226 (switch control device) is a logic IC (IC: Integrated Circuit) (FIG. 2). However, for example, in terms of transmitting the second drive signal S2 to the second switch 222 when predetermined conditions are satisfied, the present invention is not limited in this respect. For example, instead of the logic IC, a CPU and programs may be used to form the switch control device.

### <B-2. Control>

In the first travel control and the second travel control according to the above embodiment, at least one of acceleration, deceleration, steering, and speed conversion of the vehicle 10 is performed automatically. However, in terms of performing ON/OFF control of supplying electric power using the third switch 224 having the coil 290 (signal input part) of the first electric power system 130 and the contact part 292 (conductive part) of the second electric power system 132, and the signal line 260 from the switch control circuit 226, the present invention is not limited in this respect. For example, the first travel control or the second travel control may perform control other than the control of automatically performing at least one of acceleration, deceleration, steering, and speed conversion of the vehicle 10.

In the above embodiment, the first travel control (or the first travel ECU 32) is used normally, and the second travel control (or the second travel ECU 82) is used for fail-safe (FIG. 3). However, for example, in terms of performing ON/OFF of the second travel ECU 82 using the third switch 224 having the coil 290 (signal input part) of the first electric power system 130 and the contact part 292 (conductive part) of the second electric power system 132, and the signal line 260 from the switch control circuit 226, the present invention is not limited in this respect. For example, the second travel control (or the second travel ECU 82) may be used normally, and the first travel control (or the first travel ECU 32) may be used for fail-safe. Alternatively, it may be possible to use both of the first travel control (or the first travel ECU 32) and the second travel control (or the second travel ECU 82) normally.

### <B-3. Other>

In the above embodiment, the switch control circuit 226 is operated in accordance with the flow shown in FIG. 4. However, as long as it is possible to obtain the advantages of the present invention, the content of flow (the order of the steps) is not limited in this respect. For example, the order of step S22 and S23 may be interchanged.

The above embodiment can be summarized as below.

The electric power supply apparatus (120) includes: the first power supply (150) that supplies electric power to the first control device (32) configured to control the vehicle (10); the second power supply (220) that supplies electric power to the second control device (82) configured to control the vehicle; the starter switch (152) configured to be operated by an occupant; and the control unit (226) that starts or stops the vehicle based on a change in voltage of the starter switch that occurs when the starter switch is operated, wherein the starter switch is in a state of being connected to the first power supply and the second power supply, and when the starter switch is operated, electric power is supplied to the starter switch from at least one of the first power supply and the second power supply. According to the structure, even if one of the first power supply and the second power supply fails, electric power can be supplied to the starter switch from the other of the first power supply and the second power supply. Therefore, even if one of the first power supply and the second power supply fails, a change in voltage of the starter switch occurs without fail when the starter switch is operated. Therefore, according to this structure, the vehicle can be started or stopped without fail based on the operation of the starter switch. That is, according to this structure, the electric power supply apparatus can suitably be used in the structure having two electric power systems.

The electric power supply apparatus may further include: the second switch (222) configured to perform ON/OFF switching of supply of electric power from the second power supply to the second control device; and the third switch (224) configured to perform ON/OFF switching of a first drive signal (S1) to the second switch, wherein the control unit may output a second drive signal (S2) to the second switch when a predetermined condition is satisfied, the second switch may be turned on when the first drive signal or the second drive signal is inputted, the second switch may be turned off when the first drive signal and the second drive signal are not inputted, and the second control device may permit driving assistance performed by the second control device when abnormality occurs in the first control device while the predetermined condition is satisfied and the control unit keeps the second switch in the ON state with the second drive signal. While the third switch is not used, the second switch may be turned on. However, in such a case, if the electric power for turning on the second switch is supplied from the first electric power supply, interruption of the supply of electric power from the first electric power supply disrupts the turning-on of the second switch. According to this structure, the second switch is turned on when the first drive signal or the second drive signal is inputted, and the second switch is turned off when the first drive signal and the second drive signal are not inputted. Thus, even if the “third switch” cannot stay in the ON state because of the interruption of the supply of electric power from the first electric power supply, the second switch can be kept in the ON state due to the second drive signal coming from the switch control device. In other words, even if the first control device stops and the third switch is turned off due to the interruption of the supply of electric power from the first electric power supply, the supply of electric power from the second electric power supply to the second control device can continue while the second switch is kept in the ON state due to the second drive signal. Moreover, even in the case where the second drive signal cannot be inputted to the second switch for some reasons (disconnection of the signal line for the second drive signal, etc.), it becomes possible to continue supply of electric power to the second control device by inputting the first drive signal to the second switch.

The electric power supply apparatus may further include a first switch (156) configured to perform ON/OFF switching of supply of electric power from the first power supply to the first control device, wherein the first switch and the third switch may be turned on by operation of the starter switch by the occupant. According to the structure, the occupant operates the starter switch, whereby the supply of electric power to the first control device and the second control device can be started. That is, when the first switch is turned on, the supply of electric power from the first electric power supply to the first control device starts. When the third switch is turned on, the first drive signal is inputted to the second switch, which as a result is turned on. Thus, the supply of electric power from the second electric power supply to the second control device starts.

Start of output of the second drive signal by the control unit may be triggered when operation of a drive source of the vehicle is started or when the occupant provides an instruction to start driving assistance performed by the first control device or the second control device. According to the structure, it becomes possible to supply electric power to the second control device in a situation where it is highly necessary to supply electric power to the second control device. In a case where start of output of the second drive signal is triggered by the activation of the drive source of the vehicle, electric power is supplied to the second control device and the second control device is activated before an instruction to start driving assistance is given by the occupant, whereby driving assistance performed by the second control device can be started immediately after the instruction is given. In a case where start of output of the second drive signal is triggered by an event that the occupant has given an instruction to start driving assistance performed by the first control device or the second control device, it becomes possible to suppress standby electric power of the second control device before the driving assistance is executed. In particular, in a case where start of the output of the second drive signal is triggered by an event that the occupant has given an instruction to start driving assistance performed by the first control device, even if electric power from the first electric power supply cannot be supplied to the first control device, etc. for some reasons, it is possible to perform driving assistance with the second control device.

The second control device may include the control unit and the second control device may permit the driving assistance performed by the second control device when abnormality occurs in the first control device while the predetermined condition is satisfied and the control unit keeps the second switch in the ON state with the second drive signal after electric power is supplied from the second power supply to the second control device when the second switch is turned on. According to the structure, even if the first control device cannot perform driving assistance, the second control device can perform driving assistance.

The control unit may stop outputting the second drive signal when the starter switch of the vehicle is turned off, or when driving assistance performed by the first control device and the second control device is stopped. According to the structure, the supply of electric power to the second control device can be stopped at suitable timing.

The first control device may perform first travel control to perform at least one of acceleration, deceleration, steering, and speed conversion of the vehicle automatically, and the second control device may perform second travel control to perform at least one of acceleration, deceleration, steering, and speed conversion of the vehicle automatically. In the structure where automatic control can be performed separately by the two control devices (first and second control devices), even when the first to third switches are used as described above, it is possible to suitably achieve desired redundancy.

The first control device and the second control device may be capable of performing driving assistance, and the second control device may perform driving assistance as fail-safe for driving assistance performed by the first control device when abnormality occurs in the first control device during the driving assistance performed by the first control device.

The vehicle includes the electric power supply apparatus above.

What is claimed is:

1. An electric power supply apparatus comprising:
a first power supply configured to supply electric power to a first control device configured to control a vehicle;
a second power supply configured to supply electric power to a second control device configured to control the vehicle;
a starter switch configured to be operated by an occupant; and
a control circuit configured to start or stop the vehicle based on a change in voltage of the starter switch that occurs when the starter switch is operated,
wherein the starter switch is in a state of being connected to the first power supply and the second power supply, and
when the starter switch is operated, electric power is supplied to the starter switch from at least one of the first power supply and the second power supply.

2. The electric power supply apparatus according to claim 1, further comprising:
a second switch configured to perform ON/OFF switching of supply of electric power from the second power supply to the second control device; and
a third switch configured to perform ON/OFF switching of a first drive signal to the second switch,
wherein
the control circuit outputs a second drive signal to the second switch when a predetermined condition is satisfied,
the second switch is turned on when the first drive signal or the second drive signal is inputted,
the second switch is turned off when the first drive signal and the second drive signal are not inputted, and
the second control device permits driving assistance performed by the second control device when abnormality occurs in the first control device while the predetermined condition is satisfied and the control circuit keeps the second switch in an ON state with the second drive signal.

3. The electric power supply apparatus according to claim 2, further comprising a first switch configured to perform ON/OFF switching of supply of electric power from the first power supply to the first control device,
wherein the first switch and the third switch are turned on by operation of the starter switch by the occupant.

4. The electric power supply apparatus according to claim 2, wherein start of output of the second drive signal by the control circuit is triggered when operation of a drive source of the vehicle is started or when the occupant provides an instruction to start driving assistance performed by the first control device or the second control device.

5. The electric power supply apparatus according to claim 2, wherein
the second control device includes the control circuit, and
the second control device permits the driving assistance performed by the second control device when abnormality occurs in the first control device while the predetermined condition is satisfied and the control circuit keeps the second switch in the ON state with the second drive signal after electric power is supplied from the second power supply to the second control device when the second switch is turned on.

6. The electric power supply apparatus according to claim 2, wherein the control circuit stops outputting the second drive signal when the starter switch of the vehicle is turned off, or when driving assistance performed by the first control device and the second control device is stopped.

7. The electric power supply apparatus according to claim 1, wherein
the first control device performs first travel control to perform at least one of acceleration, deceleration, steering, and speed conversion of the vehicle automatically, and
the second control device performs second travel control to perform at least one of acceleration, deceleration, steering, and speed conversion of the vehicle automatically.

8. The electric power supply apparatus according to claim 1, wherein
the first control device and the second control device are allowed to perform driving assistance, and
the second control device performs driving assistance as fail-safe for driving assistance performed by the first control device when abnormality occurs in the first control device during the driving assistance performed by the first control device.

9. A vehicle comprising an electric power supply apparatus,
the electric power supply apparatus comprising:
a first power supply configured to supply electric power to a first control device configured to control the vehicle;
a second power supply configured to supply electric power to a second control device configured to control the vehicle;
a starter switch configured to be operated by an occupant; and
a control circuit configured to start or stop the vehicle based on a change in voltage of the starter switch that occurs when the starter switch is operated,
wherein the starter switch is in a state of being connected to the first power supply and the second power supply, and
when the starter switch is operated, electric power is supplied to the starter switch from at least one of the first power supply and the second power supply.
